(19) United States
(12) Patent Application Publication
(10) Pub. No.: US 2026/0057876 A1
(43) Pub. Date: Feb. 26, 2026

(54) ELECTRONIC DEVICE FOR PERFORMING ACTIVE NOISE CANCELLATION AND CONTROL METHOD THEREOF

(71) Applicant: Samsung Electronics Co., Ltd., Suwon-si (KR)

(72) Inventors: Pawel DANILUK, Warszawa (PL); Mateusz LITWIN, Warszawa (PL); Jakub TKACZUK, Warszawa (PL); Michal KACZMAREK, Warszawa (PL); Kyoungbo MIN, Suwon-si (KR); Sooyeon PARK, Suwon-si (KR)

(21) Appl. No.: 19/377,800

(22) Filed: Nov. 3, 2025

Related U.S. Application Data
(63) Continuation of application No. PCT/KR2025/000128, filed on Jan. 3, 2025.

(30) Foreign Application Priority Data
Jan. 3, 2024 (KR) 10-2024-0001015

(51) Int. Cl. G10K 11/178

(52) U.S. Cl. CPC G10K 11/178

(57) ABSTRACT

A method performed by an electronic device for active noise cancellation is provided. The method includes acquiring, by the electronic device, a noise signal, inputting, by the electronic device, a plurality of audio samples constituting the noise signal to a filter including a plurality of stages, and generating, by the electronic device, an anti-noise signal for attenuating the noise signal using data output from the plurality of stages.

### CROSS-REFERENCE TO RELATED APPLICATION(S)

This application is a bypass continuation of International Application No. PCT/KR2025/000128, filed on Jan. 3, 2025, which is based on and claims priority to Korean Patent Application No. 10-2024-0001015, filed on Jan. 3, 2024, in the Korean Intellectual Property Office, the disclosures of which are incorporated by reference herein in their entireties.

### TECHNICAL FIELD

The disclosure relates to an electronic device and control method thereof. More particularly, the disclosure relates to an electronic device for performing active noise cancellation (ANC) and a control method thereof.

### BACKGROUND ART

Electronic devices may provide functions related to audio signal processing. For example, the electronic device may provide call functions that collect and transmit audio signals, recording functions that record audio signals, or the like.

The electronic device that outputs audio may be equipped with various noise cancellation and suppression technologies to distinguish voice signals. For example, headphones may acquire surrounding noise through a microphone connected to a noise cancellation circuit and output an anti-noise signal having an anti-phase to the acquired noise. Users may hear both the surrounding noise and the noise having an anti-phase noise together, thereby achieving the effect of noise cancellation.

The above information is presented as background information only to assist with an understanding of the disclosure. No determination has been made, and no assertion is made, as to whether any of the above might be applicable as prior art with regard to the disclosure.

### SUMMARY

### Technical Solution

Aspects of the disclosure are to address at least the above-mentioned problems and/or disadvantages and to provide at least the advantages described below. Accordingly, an aspect of the disclosure is to provide an electronic device for performing active noise cancellation and a control method thereof.

Additional aspects will be set forth in part in the description which follows and, in part, will be apparent from the description, or may be learned by practice of the presented embodiments.

In accordance with an aspect of the disclosure, a method performed by an electronic device for active noise cancellation is provided. The method includes acquiring, by the electronic device, a noise signal, inputting, by the electronic device, a plurality of audio samples constituting the noise signal to a filter including a plurality of stages, and generating, by the electronic device, an anti-noise signal for attenuating the noise signal using data output from the plurality of stages.

The inputting of the plurality of audio samples constituting the noise signal to the filter including the plurality of stages includes inputting the plurality of audio samples to each of the plurality of stages at different sampling rates.

The method further includes compressing an original filter to a different level in each of the plurality of stages.

Each of the plurality of stages includes the same number of coefficients.

The inputting of the audio sample constituting the noise signal to the filter including the plurality of stages includes inputting the same number of audio samples to each of the plurality of stages.

The inputting of the plurality of audio sample constituting the noise signal to the filter divided into the plurality of stages includes down-sampling adjacent audio samples into one audio sample, and inputting the down-sampled one audio sample to one of the plurality of stages.

The filter includes a first stage and a second stage, and the inputting of the plurality of audio sample constituting the noise signal to the filter including the plurality of stages includes inputting two audio samples to a first buffer memory corresponding to the first stage, when the two audio samples are input to the first buffer memory, down-sampling two audio samples in the oldest order among the audio samples stored in the first buffer memory into one audio sample, and inputting the down-sampled one audio sample to a second buffer memory corresponding to the second stage.

The method further includes inputting the audio sample stored in the first buffer memory to the first stage of the filter.

The filter further includes a first filter configured to filter an external noise signal acquired through an external microphone, a second filter configured to generate a first feedback signal from an internal noise signal acquired through an internal microphone and have a coefficient dynamically adjusted, and a third filter configured to generate a second feedback signal from the internal noise signal acquired through the internal microphone and have a coefficient fixed.

The third filter further includes a feedback module that excludes an output of the third filter from the internal noise signal acquired through the internal microphone.

The method further includes identifying a path through which a sound output from a speaker reaches the internal microphone located inside the electronic device and determining a coefficient of the third filter using the identified path.

The inputting of the plurality of audio sample constituting the noise signal to the filter including the plurality of stages includes inputting the noise signal to the first filter and the second filter while determining the coefficient of the second feedback filter.

In accordance with another aspect of the disclosure, an electronic device for performing active noise cancellation is provided. The electronic device includes at least one microphone, a speaker, memory storing one or more computer programs, and one or more processors communicatively coupled to the at least one microphone, the speaker, and the memory, wherein the one or more computer programs include computer-executable instructions that, when executed by the one or more processors individually or collectively, cause the electronic device to acquire a noise signal through the at least one microphone, input a plurality of audio samples constituting the noise signal to a filter including a plurality of stages, and output an anti-noise signal for attenuating the noise signal using data output from the plurality of stages.

The one or more computer programs further include computer-executable instructions that, when executed by the one or more processors individually or collectively, cause the electronic device to input the plurality of audio samples into each of the plurality of stages at different sampling rates.

The one or more computer programs further include computer-executable instructions that, when executed by the one or more processors individually or collectively, cause the electronic device to compress an original filter at different levels in each of the plurality of stages.

Each of the plurality of stages includes the same number of coefficients.

The one or more computer programs further include computer-executable instructions that, when executed by the one or more processors individually or collectively, cause the electronic device to input the same number of audio samples to each of the plurality of stages.

The one or more computer programs further include computer-executable instructions that, when executed by the one or more processors individually or collectively, cause the electronic device to down-sample adjacent audio samples into one audio sample, and input the down-sampled one audio sample to one of the plurality of stages.

The filter includes a first stage and a second stage, and the processor is configured to input two audio samples to a first buffer memory corresponding to the first stage, and when the two audio samples are input to the first buffer memory, down-sample two audio samples among the audio samples stored in the first buffer memory in the oldest order into one audio sample, and input the down-sampled one audio sample into a second buffer memory corresponding to the second stage.

In accordance with another aspect of the disclosure, one or more non-transitory computer-readable storage media storing one or more computer programs including computer-executable instructions that, when executed by one or more processors of an electronic device individually or collectively, cause the electronic device to perform operations is provided. The operations include acquiring, by the electronic device, a noise signal, inputting, by the electronic device, a plurality of audio samples constituting the noise signal to a filter including a plurality of stages, and generating, by the electronic device, an anti-noise signal for attenuating the noise signal using data output from the plurality of stages.

According to an embodiment of the disclosure, a computer-readable recording medium on which a program for executing any one of the above-described methods and methods to be described below for performing active noise cancellation by an electronic device is recorded is provided.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a diagram for describing an audio signal processing system according to an embodiment of the disclosure;

FIGS. 2 and 3 are diagrams for describing noise cancellation according to various embodiments of the disclosure;

FIG. 4 is a block diagram for describing a configuration of an electronic device according to an embodiment of the disclosure;

FIG. 5 is a diagram for describing an operation of a filter module according to an embodiment of the disclosure;

FIG. 6 is a diagram for describing the filter module according to an embodiment of the disclosure;

FIG. 7 is a diagram for describing the filter module according to an embodiment of the disclosure;

FIG. 8 is a diagram for describing the filter module according to an embodiment of the disclosure;

FIG. 9 is a diagram for describing the filter module according to an embodiment of the disclosure;

FIG. 10 is a diagram for describing an operation of a plurality of modules according to an embodiment of the disclosure;

FIG. 11 is a diagram for describing a method of compressing a filter by the electronic device according to an embodiment of the disclosure;

FIG. 12 is a diagram for describing a method of inputting an audio sample to a filter by the electronic device according to an embodiment of the disclosure;

FIGS. 13, 14, 15, and 16 are diagrams for describing a method of down-sampling an audio sample by the electronic device and inputting the down-sampled audio sample to each stage of a filter according to various embodiments of the disclosure;

FIGS. 17 and 18 are diagrams for describing noise performance according to a combination of filter modules according to various embodiments of the disclosure;

FIGS. 19 and 20 are diagrams for describing noise performance according to a compressed degree of a filter module according to various embodiments of the disclosure; and

FIG. 21 is a diagram for describing a control method of an electronic device according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the specification, an expression “have,” “may have,” “include,” “may include,” or the like, indicates existence of a corresponding feature (for example, a numerical value, a function, an operation, a component such as a part, or the like), and does not exclude existence of an additional feature.

In the disclosure, an expression “A or B,” “at least one of A and/or B,” or “one or more of A and/or B,” may include all possible combinations of items enumerated together. For example, “A or B,” “at least one of A and B,” or “at least one of A or B” may indicate all of 1) a case where at least one A is included, 2) a case where at least one B is included, or 3) a case where both of at least one A and at least one B are included.

Expressions “first” or “second” used in the disclosure may indicate various components regardless of a sequence and/or importance of the components, will be used only to distinguish one component from the other components, and do not limit the corresponding components.

When it is mentioned that any component (for example, a first component) is (operatively or communicatively) coupled with/to or is connected to another component (for example, a second component), it is to be understood that any component is directly coupled to another component or may be coupled to another component through the other component (for example, a third component).

On the other hand, when it is mentioned that any component (for example, a first component) is “directly coupled” or “directly connected” to another component (for example, a second component), it is to be understood that the other component (for example, a third component) is not present between any component and another component.

An expression “configured (or set) to” used in the disclosure may be replaced by an expression “suitable for,” “having the capacity to,” “designed to,” “adapted to,” “made to,” or “capable of” depending on a situation. A term “configured (or set) to” may not necessarily mean “specifically designed to” in hardware.

Instead, in some situations, an expression “apparatus configured to” may mean that the apparatus may “do” together with other apparatuses or components. For example, a “processor configured (or set) to perform A, B, and C” may mean a dedicated processor 160 for performing the corresponding operations or a generic-purpose processor 160 (for example, a central processing unit (CPU) or an application processor) that may perform the corresponding operations by executing one or more software programs stored in a memory apparatus.

In embodiments, a ‘module’ or a ‘˜er/or’ may perform at least one function or operation, and be implemented by hardware or software or be implemented by a combination of hardware and software. In addition, a plurality of “modules” or a plurality of “˜ers/ors” may be integrated in at least one module and be implemented by at least one processor except for a ‘module’ or an ‘˜er/or’ that needs to be implemented by specific hardware.

The disclosure relates to a method of canceling noise by performing an “active noise cancellation” operation.

In the disclosure, the “active noise cancellation” means an operation of canceling noise by outputting an anti-noise signal of an opposite phase to noise using one or more filters. In the disclosure, an electronic device may acquire an anti-noise signal by passing an audio sample constituting a noise signal through a filter.

In the disclosure, a “filter” means a digital filter that generates a fixed-length response to an input signal. The filter may include a certain number of coefficients. When the audio sample is input, the filter may generate an output signal through a convolution operation between the coefficients and the input audio sample. In the disclosure, the “coefficient” of the filter may be replaced with an expression representing the same/similar concept, such as a tap of the filter, a “filter coefficient” of the filter, a “weight” of the filter, and a “parameter” of the filter.

In this disclosure, the “audio sample” means an individual data point converted into discrete digital data through a sampling process of an audio signal. The sampling process means a process of measuring an analog audio signal at specific intervals and recording each measured value in a digital form. The audio sample is defined by a sampling rate (a rate indicating the number of times an audio sample is measured per second) and a bit depth (the number of bits used to represent an audio sample).

According to one or more embodiments of the disclosure, the filter may be a finite impulse response (FIR) filter. According to one or more embodiments of the disclosure, the filter may be an infinite impulse response (IIR) filter. According to one or more embodiments of the disclosure, an electronic device may perform active noise cancellation by combining a plurality of FIR filters. According to one or more embodiments of the disclosure, the electronic device may perform the active noise cancellation by combining one or more FIR filters and one or more IIR filters.

In the disclosure, a “span” of a filter may indicate the number of audio samples required for the filter to perform a calculation. That is, the span of the filter may mean how many previous audio samples the filter calculates on for the input signal. In the disclosure, the “span” of the filter may be replaced with an expression representing the same/similar concept, such as the “order” of the filter and the “size” of the filter.

In the disclosure, the filter may include a plurality of stages. In the disclosure, the “stage” of the filter may mean an individual step in which the filter processes input data. Each stage of the filter may sequentially apply a specific calculation to the input data. Specifically, each stage of the filter may mean a unit that performs a convolution operation with audio samples that constitute a noise signal. For example, a first group of the input audio samples may perform a first convolution operation with a first stage of the filter, and a second group of the input audio samples may perform a second convolution operation with a second stage. In the disclosure, the “stage” may be replaced with an expression representing the same/similar concept, such as “step,” “interval,” “region,” “time interval,” “time domain,” and “processing unit.”

According to one or more embodiments of the disclosure, in order to reduce the computational resource consumption of the filter while maintaining the span of the filter, each stage of the filter may be compressed to different levels.

In the disclosure, the “compression” of the filter means an operation of reducing the computational consumption of the filter by replacing multiple coefficients among the coefficients of the filter with one coefficient.

According to one or more embodiments of the disclosure, the electronic device may replace an average value of multiple coefficients with a value of one coefficient. Alternatively, the electronic device may replace a value of the highest coefficient among values of multiple coefficients with a value of one coefficient. Alternatively, the electronic device may replace a weighted average value of multiple coefficients with a value of one coefficient. Alternatively, the electronic device may use statistical techniques to replace a value of the most characteristic coefficient with a value of one coefficient.

Alternatively, the electronic device may use an optimization algorithm such as a least squares method to remove coefficients with low importance and replace values of coefficients with high importance with a value of one coefficient.

In the disclosure, the “compression” of the filter may be replaced with an expression representing the same/similar concept, such as “coefficient sharing.”

In the disclosure, each stage of the filter may be compressed to a specific “level.” The level may mean the degree to which the coefficients included in each stage of the filter are compressed. The higher the compression level, the more the number of multiple coefficients replaced with one coefficient may increase.

For example, when the first stage is compressed to the first level, eight coefficients included in the first stage may be compressed to four coefficients. When the second stage is compressed to the second level, 16 coefficients included in the second stage may be compressed to 4 coefficients.

In the disclosure, the “compression level” may be replaced with an expression representing the same/similar concept, such as “compression degree.”

Meanwhile, various elements and regions in the drawings are schematically illustrated. Therefore, the spirit of the disclosure is not limited by relatively sizes or intervals illustrated in the accompanying drawings.

Hereinafter, embodiments of the disclosure will be described in detail with reference to the accompanying drawings so that those skilled in the art to which the disclosure pertains may easily practice the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

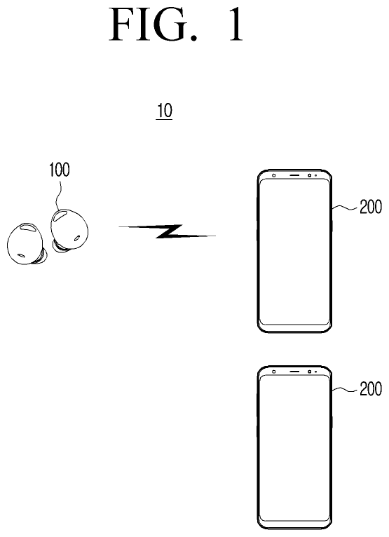

FIG. 1 is a diagram for describing an audio signal processing system according to an embodiment of the disclosure.

Referring to FIG. 1, an audio signal processing system 10 may include an electronic device 100 and an external device 200.

The electronic device 100 may be a device for playing audio. According to one or more embodiments of the disclosure, the electronic device 100 may be an earphone having an active noise canceling function. According to one or more embodiments of the disclosure, the electronic device 100 may be a mobile device that a user can carry, a wearable device that a user can wear on his or her body, a smart device having its own audio processing function, a true wireless (TWS) device, a hearable device, intelligent Earbuds, an intelligent headphone, or an artificial intelligence speaker, and may be implemented in various forms without being limited thereto.

In the disclosure, the electronic device 100 may receive an audio signal corresponding to a sound acquired from outside the electronic device 100 through a microphone configured as a part of the electronic device 100. The electronic device 100 may be wirelessly connected to an external device 200 directly through a connection terminal or through a wireless communication module (e.g., a Bluetooth communication module) to transmit the audio signal acquired by the electronic device 100 or receive the audio signal from the external device 200. The electronic device 100 may receive a control signal (e.g., a noise cancellation operation signal received through an input button) related to the audio signal acquired from the external device 200. According to an embodiment, the electronic device 100 may receive information related to processing of the audio signal from the external device 200.

In the disclosure, the electronic device 100 may perform various processing on the received audio signal. For example, the electronic device 100 may perform noise processing (e.g., noise or echo reduction), application of one or more filters, change in a sampling rate, interpolation processing, amplification or attenuation of all or part of a frequency band, a channel change (e.g., switching between mono and stereo), mixing, or extraction of a specified signal on one or more audio signals.

According to one or more embodiments of the disclosure, one or more audio signal processing functions of the electronic device 100 may be implemented by a digital signal processor (DSP). According to one or more embodiments of the disclosure, one or more audio signal processing functions of the electronic device 100 may be implemented by a dedicated neural processing unit (NPU).

In the disclosure, the electronic device 100 may output an audio signal to the outside of the electronic device 100 through a speaker configured as a part of the electronic device 100.

In the disclosure, the external device 200 may be a device for processing audio. According to one or more embodiments of the disclosure, the external device 200 may be a device capable of controlling the electronic device 100. In various embodiments, the external device 200 may be a mobile device that a user can carry. For example, the external device 200 may include at least one of a smart phone, a tablet personal computer (PC), a mobile phone, an e-book reader, a laptop personal computer (laptop PC), a netbook computer, a personal digital assistant (PDA), a portable multimedia player (PMP), and an MP3 player. Of course, it is not limited to the above example.

In the disclosure, the external device 200 may be wirelessly connected to the electronic device 100 directly through the connection terminal or through the wireless communication module (e.g., a Bluetooth communication module) to receive the audio signal from the electronic device 100 or transmit the audio signal to the electronic device 100. According to one or more embodiments of the disclosure, the external device 200 may transmit a control signal (e.g., a noise cancellation operation signal transmitted through an input button) related to the audio signal transmitted to the electronic device 100. According to an embodiment, the external device 200 may transmit the information related to the processing of the audio signal to the external device 100.

In the disclosure, the external device 200 may perform various processing on the audio signal. For example, the external device 200 may perform the noise processing (e.g., noise or echo reduction), the application of one or more filters, the change in the sampling rate, the interpolation processing, the amplification or attenuation of all or part of the frequency band, the channel change (e.g., switching between mono and stereo), the mixing, or the extraction of the specified signal on one or more audio signals.

In the disclosure, the audio signal processing system 10 may perform audio signal processing for various purposes. The audio signal processing system 10 may analyze an environment, context, or condition in which the electronic device 100 or the external device 200 is being used to determine which audio signal processing to perform. For example, the audio signal processing system 10 may process the audio signal to perform at least one of active noise cancellation, sound separation, sound enhancement, selective listening, acoustic echo cancellation, ambient pass-though, beamforming, and selective filtering. For example, the audio signal processing system 10 of the disclosure may analyze the audio signal to perform at least one of sound event detection, such as voice fingerprinting, wake-up spotters, and emergency sound detection, acoustic scene analysis, and listening target selection.

In the disclosure, the electronic device 100 and the external device 200 may be functionally coupled and operate in processing the audio signal. According to one or more embodiments of the disclosure, the electronic device 100 and the external device 200 may separately perform operations for processing the audio signal. According to one or more embodiments of the disclosure, the electronic device 100 and the external device 200 may perform different types of audio signal processing, respectively. For example, the electronic device 100 may perform processing that requires a small amount of computational resources, and the external device 200 may perform processing that requires a large amount of computational resources. For example, the electronic device 100 may perform real-time signal processing or signal processing requiring low latency, and the external device 200 may perform signal processing that operates in a relatively long cycle or does not require a large latency.

In the disclosure, the electronic device 100 may perform the active noise cancellation using one or more filters.

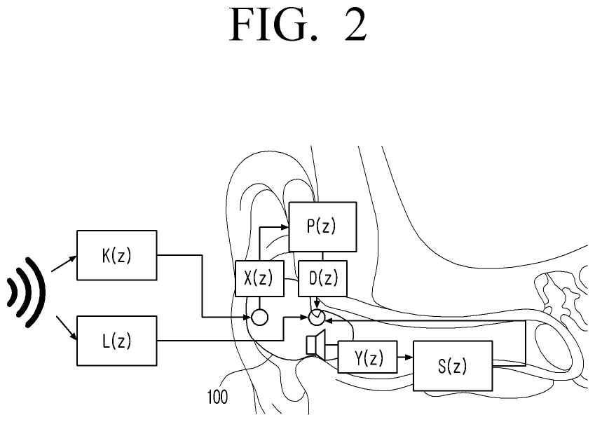

FIG. 2 is a diagram for describing a principle of noise canceling according to an embodiment of the disclosure.

The electronic device 100 performing the noise canceling may include one speaker and two microphones. For example, referring to FIG. 2, the electronic device may include a speaker that outputs sound Y(z) to an external auditory canal of a user wearing the electronic device 100, an external microphone that receives external sound K(z), and an internal microphone that receives external sound L(z) and sound inside the external auditory canal of the user.

Here, a path for the sound of the electronic device 100 may include a primary path and a secondary path.

The basic path P(z) is a transfer path between the external microphone and the internal microphone, which represents how the external sound changes when entering the ear, and may be expressed as P(z)=L(z)/K(z).

A secondary path S(z) is a transfer path between the speaker and the internal microphone, and may be expressed as S(z)Y(z)=D(z).

In the noise canceling algorithm, the secondary path is measured when the electronic device 100 is booted, and is simulated within the noise canceling algorithm, so the response to the given output S(z) may be predicted. This enables the use of an at least partially adaptive internal model control (IMC) approach in a real-time simulated acoustic system.

In the disclosure, the booting of the electronic device may mean the time when the electronic device is powered on or when the electronic device starts the noise canceling.

The noise canceling may include an operation of calculating an in-ear signal through D(z)=P(z)X(z) and an operation of calculating a speaker signal through Y(z)=D(z)/S(z). However, since S(z) has a longer latency than P(z), Y(z) may not be perfectly calculated. This limitation may also affect a convergence of an adaptive filter used for estimation.

To overcome this limitation, a noise canceling system according to one or more embodiments of the disclosure may generate a noise signal by combining various types of filter modules.

In this case, the performance of the noise canceling system may vary depending on the span of the filter.

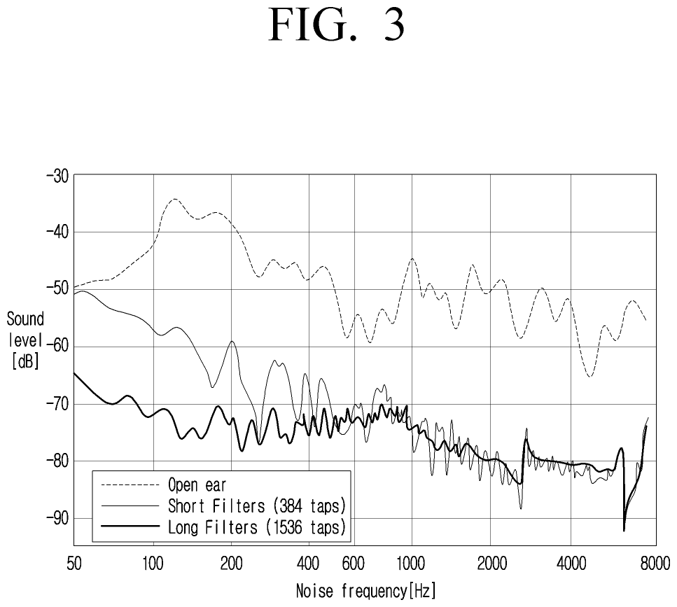

FIG. 3 is a diagram illustrating noise cancellation performance according to the span of the filter according to an embodiment of the disclosure.

Specifically, referring to FIG. 3, there is an advantage in that, when using a short filter (a short filter including 384 coefficients) or a long filter (a long filter including 1536 coefficients), noise is reduced compared to when not wearing the electronic device 100, but when using a long filter, low-frequency noise may be effectively cancelled. However, the long filter has a disadvantage in that it requires a lot of computational resources due to the large computational amount. On the contrary, the short filter has a disadvantage in that it may not effectively cancel the low-frequency noise, but has an advantage in that it requires less computational resources.

The noise cancellation method according to the disclosure may increase the computational resource consumption while maintaining the noise canceling performance by compressing the filter.

The operation of the electronic device 100 according to the disclosure performing the active noise cancellation will be described in detail with reference to the drawings below.

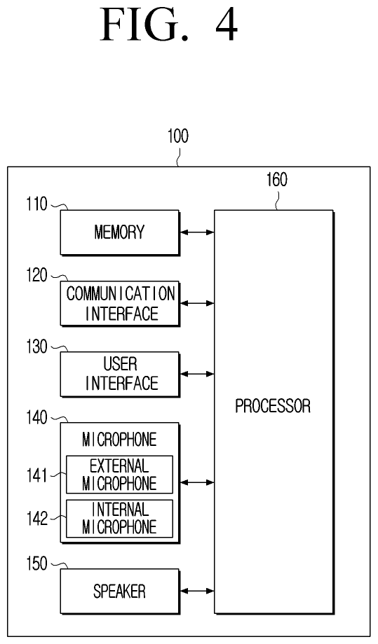

FIG. 4 is a block diagram for describing a configuration of the electronic device 100 according to an embodiment of the disclosure.

Referring to FIG. 4, the electronic device 100 may include at least one of memory 110, a communication interface 120, a user interface 130, a microphone 140, a speaker 150, and one or more processors 160.

At least one of the components may be omitted. For example, the electronic device 100 may include the memory 110, the microphone 140, the speaker 150, and the one or more processors 160. Alternatively, the electronic device 100 may further include other components in addition to the above components.

The memory 110 may store at least one instruction regarding the electronic device 100. The memory 110 may store an operating system (O/S) for driving the electronic device 100. In addition, the memory 110 may store various software programs or applications for operating the electronic device 100 according to various embodiments of the disclosure. The memory 110 may include a semiconductor memory such as a flash memory 110, a magnetic storage medium such as a hard disk, or the like.

Specifically, the memory 110 may store various software modules for operating the electronic device 100 according to diverse embodiments of the disclosure, and the one or more processors 160 may run various software modules stored in the memory 110 to control an operation of the electronic device 100. That is, the memory 110 may be accessed by the one or more processors 160, and readout, recording, correction, deletion, update, and the like, of data in the memory 120 may be performed by the one or more processors 160.

Meanwhile, in the disclosure, the term “memory” may be used as the meaning including the memory 110, a read only memory (ROM) (not illustrated) in the one or more processors 160, a random access memory (RAM) (not illustrated), or a memory card (not illustrated) (for example, a micro secure digital (SD) card or a memory stick) mounted in the electronic device 100.

In the disclosure, the memory 110 may store information on a filter for performing noise cancellation.

In the disclosure, the memory 110 may store a buffer memory and a cache memory for performing a convolution operation between the filter and the audio sample.

The communication interface 120 includes circuitry and is a component capable of communicating with external devices and servers. The communication interface 120 may communicate with an external device or server based on a wired or wireless communication method. The communication interface 120 may include a Bluetooth module (not illustrated), a Wi-Fi module (not illustrated), an infrared (IR) module, a local area network (LAN) module, an Ethernet module, etc. Here, each communication module may be implemented in the form of at least one hardware chip. The wireless communication module may include at least one communication chip performing communication according to various wireless communication standards such as zigbee, universal serial bus (USB), mobile industry processor interface camera serial interface (MIPI CSI), 3^{rd} generation (3G), 3^{rd} generation partnership project (3GPP), long term evolution (LTE), LTE advanced (LTE-A), 4^{th} generation (4G), 5^{th} generation (5G), and the like, in addition to the communication manner described above. However, this is only an example, and the communication interface 120 may use at least one communication module among various communication modules.

According to one or more embodiments of the disclosure, the communication interface 120 may perform communication with an external device 200 and receive an audio signal for outputting sound.

According to one or more embodiments of the disclosure, the communication interface 120 may receive a user input for performing the active noise cancellation from the external device 200.

The user interface 130 may acquire the user input. The user interface 130 may be implemented as a device such as a button, a touch pad, a mouse, and a keyboard or may be implemented as a touch screen that may perform both of the abovementioned display function and manipulation input function. Here, the button may be various types of buttons such as a mechanical button, a touch pad, a wheel, and the like, formed in any region such as a front surface portion, a side surface portion, a back surface portion, and the like, of a body appearance of the electronic device 100.

According to one or more embodiments of the disclosure, the user interface 130 may acquire user input for selecting a noise cancellation operation mode, etc.

The microphone 140 is a configuration for acquiring an audio signal. The microphone 140 may include an external microphone 141 and an internal microphone 142.

The external microphone 141 may be disposed on the opposite surface of the surface where the electronic device 100 is worn by a wearer. The external microphone 141 may be a microphone for measuring a noise signal (external noise signal) to be cancelled. In the disclosure, the external microphone 141 may be replaced with an expression representing the same/similar concept, such as “reference mike.” The internal microphone 142 may be disposed on a surface where the electronic device is worn by the wearer. The internal microphone 142 may be a microphone for measuring the result of the noise control of the electronic device 100. That is, the internal microphone 142 may be located at a target point for controlling noise. The electronic device 100 according to the disclosure may perform the noise cancellation so that the noise measured through the internal microphone 142 converges to 0. In the disclosure, the internal microphone 142 may be replaced with an expression representing the same/similar concept, such as “error mike.”

The speaker 150 is a configuration for outputting an audio signal. In the disclosure, the speaker 150 may output an anti-noise signal for canceling a noise signal to cancel or attenuate noise.

The one or more processors 160 may control a general operation and function of the electronic device 100. Specifically, the one or more processors 160 are connected to the configuration of the electronic device 100 including the memory 110, and executes at least one instruction stored in the memory 110 as described above to control the overall operation of the electronic device 100.

The one or more processors 160 may be implemented in various manners. For example, the one or more processors 160 may be implemented by at least one of, an application specific integrated circuit (ASIC), a logic integrated circuit, an embedded processor, a micom, a microprocessor, a hardware control logic, a hardware finite state machine (FSM), and a digital signal processor 160.

In particular, the one or more processors 160 may include one or more processors. In detail, one or more processors may include one or more of a central processing unit (CPU), a graphics processing unit (GPU), an accelerated processing unit (APU), a many integrated core (MIC), a digital signal processor (DSP), a neural processing unit (NPU), a main processing unit (MPU), a hardware accelerator, or a machine learning accelerator. One or more processors may control one or any combination of other components of the electronic device and may perform operations related to communication or data processing. One or more processors may execute one or more programs or instructions stored in memory. For example, one or more processors 160 may perform the method according to an embodiment of the disclosure by executing one or more instructions stored in the memory 120.

When the method according to one or more embodiments of the disclosure includes a plurality of operations, the plurality of operations may be performed by one processor or by a plurality of processors. That is, when a first operation, a second operation, and a third operation are performed by the method according to one or more embodiment, the first operation, the second operation, and the third operation may all be performed by a first processor, the first operation and the second operation may be performed by the first processor 160, and the third operation may also be performed by a second processor 160.

The one or more processors 160 may be implemented as a single core processor 160 including one core, or one or more multicore processors 160 including a plurality of cores (e.g., homogeneous multicore or heterogeneous multicore). When one or more processors are implemented as a multicore processor, each of the plurality of cores included in the multicore processor may include an internal memory of the processor such as a cache memory and an on-chip memory, and a common cache shared by a plurality of cores may be included in a multicore processor. In addition, each of the plurality of cores (or some of the plurality of cores) included in the multi-core processor may read and perform program instructions for independently implementing the methods according to one or more embodiment of the disclosure, and all (or part) of the plurality of cores may be linked to read and perform program instructions for implementing the method according to one or more embodiment of the disclosure.

When the method according to one or more embodiment of the disclosure includes a plurality of operations, the plurality of operations may be performed by one of a plurality of cores included in a multicore processor, or may be performed by the plurality of cores. For example, when the first operation, the second operation, and the third operation are performed by the method according to one or more embodiment, the first operation, the second operation, and the third operation may all be performed by the first core in the multicore processor, the first operation and the second operation may be performed by a first core included in the multicore processor, and the third operation may be performed by a second core included in the multicore processor.

According to one or more embodiments of the disclosure, the one or more processors 160 may be a system-on-chip (SoC) in which one or more processors and other electronic components are integrated, a single-core processor, a multi-core processor, or a core included in the single-core processor or the multi-core processor. Here, the core may be implemented as CPU, GPU, APU, MIC, DSP, NPU, a hardware accelerator, a machine learning accelerator, or the like, but embodiments of the disclosure are not limited thereto.

Operations of the one or more processors 160 for implementing various embodiments of the disclosure may be implemented through a plurality of modules.

Specifically, data for a plurality of modules according to the disclosure may be stored in the memory 110, and the one or more processors 160 may accesses the memory 110 to load the data for a plurality of modules into the memory or buffer inside the one or more processors 160 and then use the plurality of modules, thereby implementing various embodiments according to the disclosure.

However, at least one of the plurality of modules according to the disclosure may be implemented as hardware and may be included in the one or more processors 160 in the form of a system on chip.

Alternatively, at least one of the plurality of modules according to the disclosure may be implemented as a separate external device, and the electronic device 100 and each module may perform communication and perform operations according to the disclosure.

Specifically, the one or more processors 160 may control the overall operation of the electronic device 100 described below.

Hereinafter, the operation of the electronic device 100 according to the disclosure will be described in detail with reference to the attached drawings.

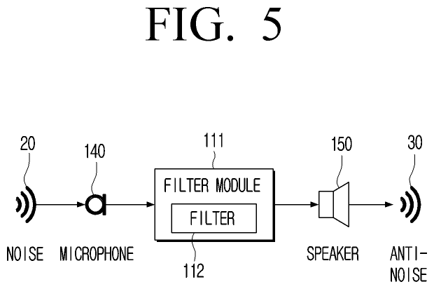

FIG. 5 is a diagram for describing an operation of a filter module according to an embodiment of the disclosure.

Referring to FIG. 5, the memory 110 may store a filter module 111 including a filter 112.

The electronic device 100 may acquire the noise signal 20 through the microphone 140. The electronic device 100 may input the acquired noise signal 20 to the filter module 111. The filter module 111 may pass the input noise signal through the filter 112 included in the filter module 111 to acquire the anti-noise signal.

The electronic device 100 may output the acquired anti-noise signal 30 through the speaker 150.

According to one or more embodiments of the disclosure, the filter module 111 may be implemented in various forms.

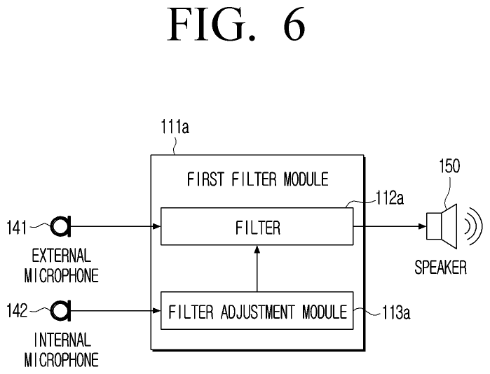

FIG. 6 is a diagram for describing the filter module 111 according to an embodiment of the disclosure.

The filter module 111 of the disclosure may be implemented in a feed-forward structure.

Here, the feed-forward structure may mean a structure in which the input signal is temporally transmitted forward and processed, and the input of the filter does not depend on the previous output of the filter.

Specifically, referring to FIG. 6, a first filter module 111a may include a filter 112a and a filter adjustment module 113a. The filter 112a may be an FIR filter configured to output the anti-noise signal when the noise signal acquired through the external microphone is input. The filter 112a may perform a calculation with the audio sample constituting the noise signal to output the anti-noise signal.

The filter adjustment module 113a may improve the performance of the filter by using the input through the internal microphone 142. Specifically, the filter adjustment module 113a may increase the noise cancellation efficiency of the filter 112a by dynamically adjusting the coefficient of the filter 112a using the noise signal acquired through the internal microphone 142.

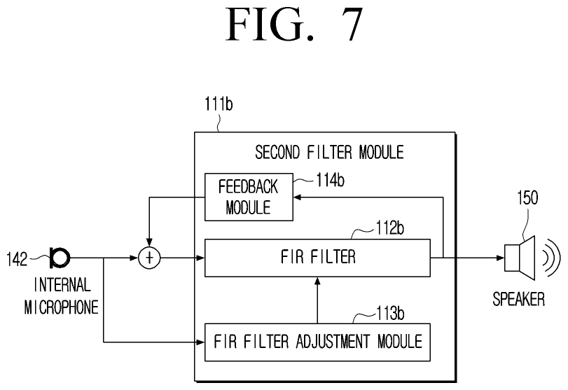

FIG. 7 is a diagram for describing the filter module according to an embodiment of the disclosure.

The filter module of the disclosure may be implemented with a feedback structure. In the disclosure, the feedback structure may be replaced with a structure representing the same/similar concept, such as a feed-backward.

Here, the feedback structure may mean a structure in which the input signal is input to the filter and processed, and then the output of the filter is input back to the filter. In other words, the feedback structure may mean a structure in which the input of the filter depends on the previous output of the filter.

Specifically, referring to FIG. 7, a second filter module 111b may include a filter 112b, a filter adjustment module 113b, and a feedback 114b module.

Since the filter and the filter adjustment module have been described through FIG. 7, the duplicate descriptions will be omitted.

Referring back to FIG. 7, the filter 111b may be an FIR filter configured to output the anti-noise signal when the noise signal acquired through the internal microphone 142 is input. That is, the filter 111b illustrated in FIG. 5 is a filter configured to cancel the noise measured through the internal microphone 142.

The feedback module 114b is a module for compensating for the effect that the signal output through the filter 111b is re-input to the internal microphone 142. That is, the noise signal acquired through the internal microphone 142 is corrected by the feedback module 114b, and the corrected audio signal may be input to the filter 112b.

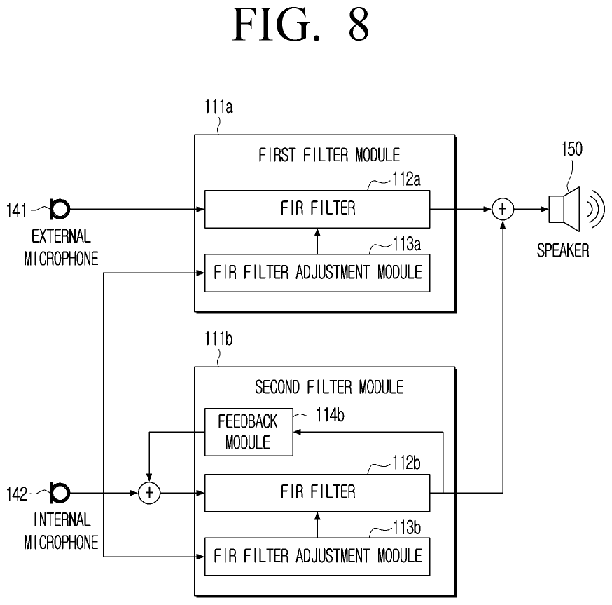

FIG. 8 is a diagram for describing the filter module according to an embodiment of the disclosure.

The filter module 111 of the disclosure may be implemented in a structure that includes a filter module implemented with a feed-forward structure and a filter module implemented with a feedback structure.

Specifically, referring to FIG. 8, the filter module 111 may include a first filter module 111a and a second filter module 111b. Since first filter module 111a has been described with reference to FIG. 4, and the second filter module 111b has been described with reference to FIG. 5, the duplicate descriptions will be omitted.

The electronic device 100 may generate the anti-noise signal by adding a signal output through the filter 112a of the first filter module 111a and the signal output through the filter 112b of the second filter module 111b. Then, the electronic device 100 may output the generated anti-noise signal through the speaker.

Meanwhile, the filter module illustrated through FIG. 8 in the disclosure may be referred to as an “adaptive hybrid ANC module.”

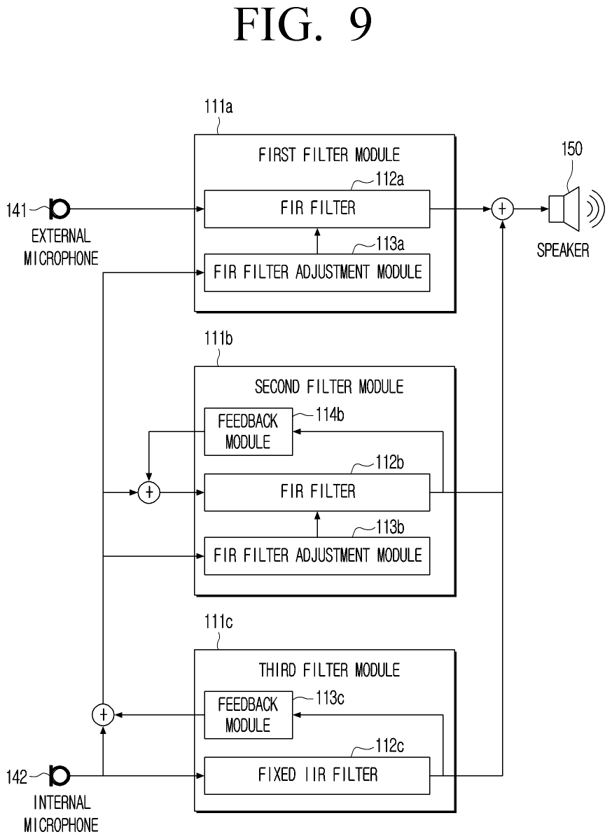

FIG. 9 is a diagram for describing the filter module according to an embodiment of the disclosure.

The filter module 111 of the disclosure may be implemented with a structure including an adaptive hybrid ANC module and a filter module of a fixed feedback structure.

Here, the fixed feedback structure may mean a structure in which the filter adjustment module that dynamically adjusts the coefficient of the filter is excluded from the filter of the feedback structure described with reference to FIG. 7.

That is, the fixed feedback structure may filter the input signal based on the fixed coefficient. The input of the fixed feedback filter may be a structure that depends on the previous output of the fixed feedback filter.

Referring to FIG. 9, the filter module 111 may include a first filter module 111a, a second filter module 111b, and a third filter 111c module. Since first filter module 111a has been described with reference to FIGS. 4 and 6, and the second filter module 111b has been described with reference to FIGS. 5 and 6, the duplicate descriptions will be omitted.

In this case, the third filter module 111c may be implemented with a fixed feedback structure. Specifically, the third filter module 111c may include a filter 112c and a feedback module 113c.

In this case, the filter 112c may be a fixed IIR filter. The fixed IIR filter has fixed coefficients, so that the consistency in the signal processing may be maintained. The fixed IIR filter may provide low latency and high signal processing efficiency.

The electronic device 100 may acquire an internal noise signal through the internal microphone 142. The electronic device 100 may input the internal noise signal to the filter 112c.

The electronic device 100 may exclude the signal output from the filter 112c from the signal input to the first filter module 111a and the second filter module 111b through the feedback module 113c.

Meanwhile, the combination of the filter modules 111 described above is only an embodiment, and the filter modules 111 of the disclosure may be combined in various forms.

For example, the filter module 111 may include only the third filter module 111c. Alternatively, the filter module 111 may include only the first filter module 111a and the third filter module 111c. Alternatively, the filter module 111 may include only the second filter module 111b and the third filter module 111c.

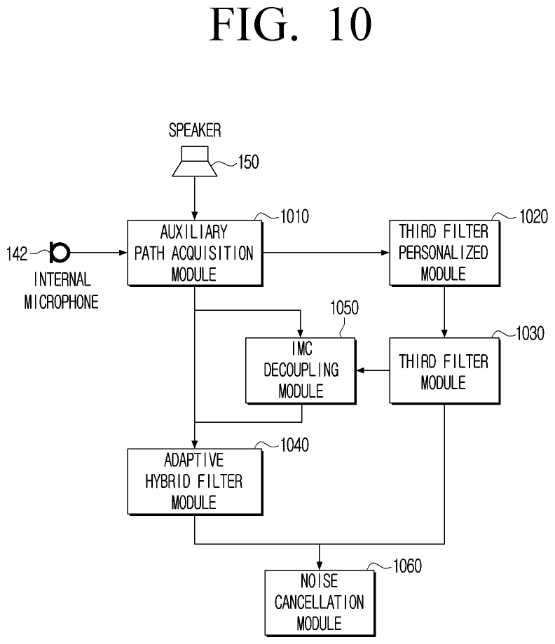

FIG. 10 is a diagram for describing an operation of a plurality of modules according to an embodiment of the disclosure.

Referring to FIG. 10, the memory 110 may include a secondary path acquisition module 1010, a third filter personalization module 1020, a third filter module 1030, an adaptive hybrid ANC module 1040, an IMC decoupling module 1050, and a noise cancellation module 1060.

When the electronic device is booted, the secondary path acquisition module 1010 may acquire the secondary path. Specifically, the secondary path acquisition module 1010 may acquire the secondary path S(z), which is a transfer path between the speaker 150 and the internal microphone 142, through the audio signal acquired through the output of the speaker 150 and the internal microphone 142.

Here, the booting of the electronic device 100 may mean the time when the electronic device is powered on or the electronic device 100 starts the noise canceling.

The third filter personalization module 1020 may acquire the personalized third filter using the secondary path. Specifically, the third filter personalization module 1020 may determine the coefficient of the third filter using the secondary path. That is, the secondary path may be acquired differently depending on the shape of an individual's external auditory canal, etc., and the third filter personalization module 1020 may determine the coefficient of the third filter module 1030 using the secondary path acquired depending on the shape of a user's external auditory canal, thereby personalizing the third filter module 1030.

Accordingly, the personalized third filter module 1030 may provide the optimized noise canceling environment to the user.

Since the adaptive hybrid filter module 1040 has been described with reference to FIG. 8, the duplicate descriptions will be omitted.

According to the disclosure, in order to reduce the boot delay of the electronic device 100, the electronic device 100 may start noise cancellation through the adaptive hybrid filter module 1040 while the third filter personalization module 1020 personalizes the third filter module 1030.

The IMC decoupling module 1050 is a module for minimizing the interdependence between the feed-forward filter module and the feedback filter module in the adaptive hybrid filter module 1040.

When the personalized third filter module 1030 is acquired by the third filter personalization module 1020, the electronic device 100 may perform the noise cancellation by combining the adaptive hybrid filter module 1040 and the third filter module.

Since the filter module in which the adaptive hybrid filter module 1040 and the third filter module 1030 are combined has been described with reference to FIG. 9, the duplicate descriptions will be omitted.

The noise cancellation module 1060 may perform noise cancellation by using data output from the adaptive hybrid filter module 1040 and the third filter module 1030.

Meanwhile, although not illustrated in the drawing, the operation of the third filter personalization module 1020 may be omitted. That is, the information on the third filter may be pre-stored in the memory 110, and the electronic device 100 may perform a noise cancellation operation using the third filter pre-stored in the memory 110.

According to one or more embodiments of the disclosure, the filter may be a filter whose coefficients are compressed. For example, the filters included in the first filter module and the second filter module illustrated in FIG. 6 may be compressed filters.

The electronic device 100 of the disclosure may compress the filter differently for each of the plurality of stages.

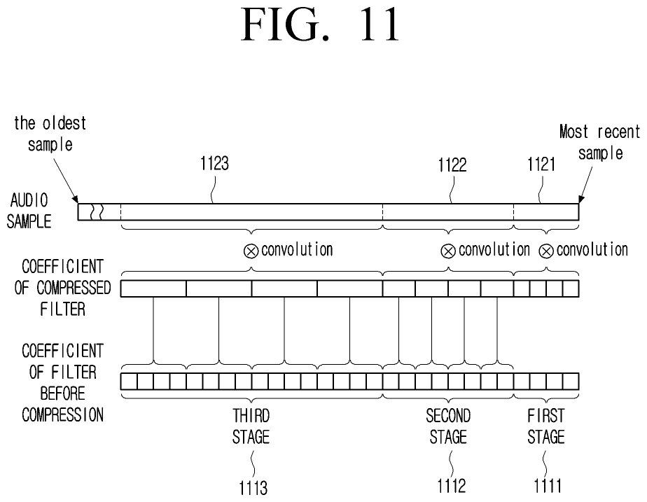

FIG. 11 is a diagram for describing a method of compressing a filter by the electronic device according to an embodiment of the disclosure. Here, the compressed filter may be an FIR filter, but is not limited thereto.

The memory 110 may store information on an uncompressed original filter.

The electronic device 100 may divide the original filter into the plurality of stages, and compress each of the plurality of stages at a different level. In this case, the larger the stage, the larger the compression level. This is because the initial response in the filter is more important and has a greater impact on the input signal.

Specifically, the electronic device 100 may divide the filter into the plurality of stages according to the input order of the coefficients. Here, the input order may mean the order in which the coefficients of the filter are applied to the input signal. In other words, the electronic device 100 may divide the original filter into multiple sections according to the degree of delay of the input processed by the coefficients constituting the filter.

For example, the electronic device 100 may divide the original filter into a first stage 1111 including coefficients whose input order is 2^{k1}th or less, a second stage 1112 including coefficients whose input order exceeds 2^{k1}th and is 2^{k2}th or less, and a third stage 1113 including coefficients whose input order exceeds 2^{k2}th and is less than 2^{k3}th. In the disclosure, k may mean any natural number. Meanwhile, the number and length of stages are not limited thereto, and may be implemented in various forms.

The electronic device 100 may compress each of the plurality of stages to the compression levels corresponding to each of the plurality of stages. In this case, the electronic device 100 may compress each of the plurality of stages so that each of the plurality of stages includes the same number of coefficients. That is, the electronic device 100 may compress each stage at the higher compression level as the number of coefficients included in the stage increases.

Specifically, a stage including coefficients with a fast input order may not be compressed or may be compressed at a low level. A stage including high coefficients with a slow input order may be compressed at a high level. In other words, a stage with a lower input delay may not be compressed or may be compressed at a low level. In other words, a stage with a larger input delay may be compressed at a high level.

For example, the electronic device 100 may not compress the first stage 1111. The electronic device 100 may compress the second stage 1112 at a first compression level. In this case, the electronic device 100 may compress the coefficients included in the second stage so that the number of coefficients in the second stage 1112 becomes 2⁻¹ of the original coefficients

The electronic device 100 may compress the third stage 1113 at a second compression level greater than the first compression level. In this case, the electronic device 100 may perform the compression so that the number of coefficients in the third stage 1113 becomes 2⁻² of the original coefficient.

For example, referring to FIG. 11, the electronic device may not compress four coefficients belonging to the first stage 1111. The electronic device may compress eight coefficients belonging to the second stage 1112 into four coefficients. The electronic device may compress 16 coefficients belonging to the third stage 1113 into four coefficients.

Accordingly, adjacent audio samples among audio samples input to each stage may be calculated by the same coefficients.

Meanwhile, the electronic device 100 according to the disclosure may compress the filter as described above, but this is only an embodiment, and the electronic device 100 may pre-store information on the pre-compressed filter in the memory 110.

The electronic device may perform a noise cancellation operation by loading a pre-compressed filter pre-stored in the memory 110.

The electronic device 100 according to the disclosure may input a plurality of audio samples to one of the plurality of stages.

Referring to FIG. 11, the electronic device 100 may perform a convolution operation with each of the first stage 1111, the second stage 1112, and the third stage 1113 of the filter in time order on the audio sample constituting the noise signal.

In this case, the electronic device 100 may input a first audio sample group 1121 including the most recently input audio sample to the first stage 1111.

Specifically, the electronic device 100 may input the first audio sample group 1121 among the audio samples constituting the noise signal to the first stage 1111 of the filter. That is, the electronic device 100 may perform a convolution operation between the first audio sample group 1121 and the coefficients of the filter constituting the first stage. In this case, the electronic device 100 may input the first audio sample group 1121 to the first stage 1111 at the first sampling rate.

The electronic device 100 may input a second audio sample group 1122 among the audio samples constituting the noise signal to the second stage 1112 of the filter. That is, the electronic device 100 may perform a convolution operation between the second audio sample group 1122 and the coefficients of the filter constituting the second stage 1112. In this case, the electronic device 100 may input the second audio sample group 1122 to the second stage 1112 at the second sampling rate lower than the first sampling rate.

For example, the electronic device 100 may input a signal of the second audio sample group 1122 down-sampled by ½ at the first sampling rate to the second stage 1112.

The electronic device 100 may input a third audio sample group 1123 among the audio samples to the third stage 1113 of the filter. That is, the electronic device 100 may perform a convolution operation between the third audio sample group 1123 and the coefficients of the filter constituting the third stage 1113. In this case, the electronic device 100 may input the third audio sample group 1123 to the third stage 1113 at the third sampling rate lower than the second sampling rate.

For example, the electronic device 100 may input a signal of the third audio sample group 1123 down-sampled by ½ at the second sampling rate (i.e., a signal down-sampled by ¼ at the first sampling rate) to the third stage 1113.

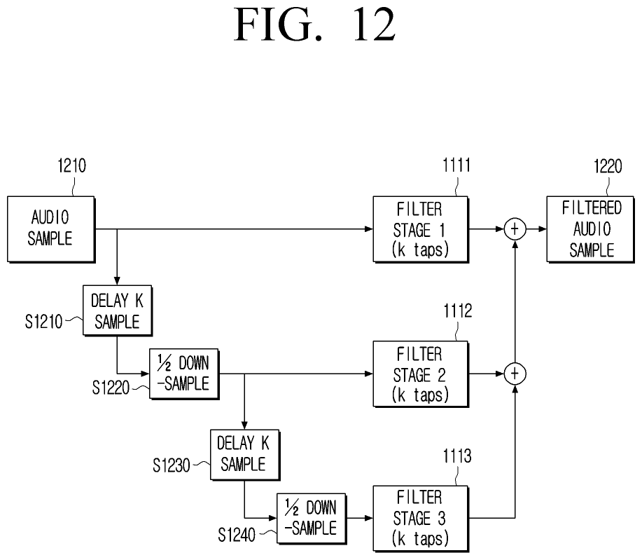

A method of inputting, by the electronic device 100, a plurality of audio sample groups to each of the plurality of stages at different sampling rates will be described below with reference to FIG. 12.

FIG. 12 is a diagram for describing a method for inputting an audio sample to a filter by the electronic device 100 according to an embodiment of the disclosure.

Referring to FIG. 12, the electronic device 100 may input k audio samples from the audio sample 1210 to the first stage 1111 of the filter in the recently acquired order. In this case, the electronic device 100 may input k audio samples recently acquired at the first sampling rate to the first stage 1111.

In this case, the first sampling rate may be the same as the sampling rate at which the audio sample is acquired, but is not limited thereto, and the electronic device 100 may down-sample the audio sample to the first sampling rate and input the down-sampled audio sample to the first stage 1111.

The electronic device 100 may input the number of audio samples constituting the noise signal, equal to the number k of coefficients of the first stage, from the most recent order, to the first stage 1111. That is, the electronic device 100 may perform a convolution operation between the acquired k audio samples and the coefficients of the first stage 1111 of the filter.

In addition, the electronic device 100 may delay k samples from the audio sample in operation S1210 and down-sample the subsequent audio sample by ½ in operation S1220. That is, the electronic device 100 may down-sample the remaining audio samples except for the audio sample input to the first stage 1111 from the audio sample 1210 by ½.

The electronic device 100 may input k audio samples among the down-sampled audio samples to the second stage 1112. That is, the electronic device 100 may perform a convolution operation between the acquired k audio samples and the coefficients of the second stage 1112 of the filter.

Thereafter, the electronic device 100 may delay k samples from the audio sample again in operation S1230 and down-sample the subsequent audio sample by ½ in operation S1240. The electronic device 100 may input k audio samples among the down-sampled audio samples to the third stage 1113 of the filter. That is, the electronic device 100 may perform a convolution operation between the acquired k audio samples and the coefficients of the third stage 1113 of the filter.

The electronic device 100 may acquire a filtered audio sample 1220 by adding data output from each stage of the filter.

The electronic device 100 may generate anti-noise using the filtered audio sample 1220.

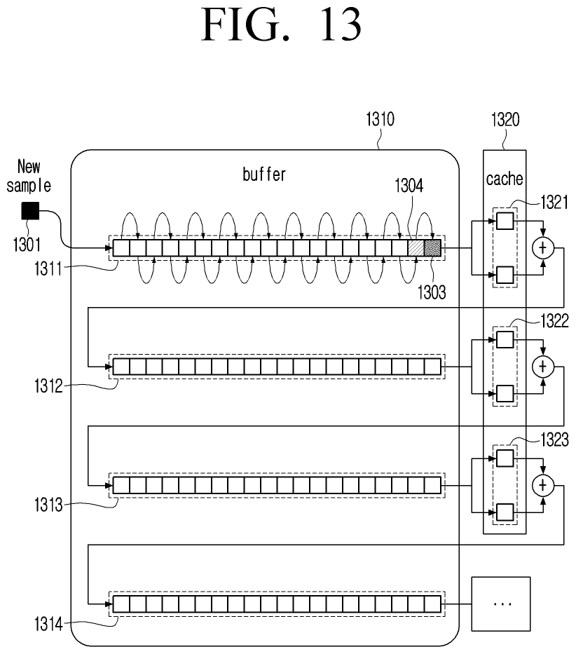

A more detailed method of down-sampling the audio sample by the electronic device 100 and inputting the down-sampled audio sample to each stage of the filter will be described with reference to FIGS. 13 to 16 below.

FIGS. 13, 14, 15, and 16 are diagrams for describing a method of down-sampling an audio sample by the electronic device and inputting the down-sampled audio sample to each stage of a filter according to various embodiments of the disclosure.

Referring to FIG. 13, the electronic device 100 may store audio samples constituting a noise signal in the buffer memory 110. Specifically, the electronic device 100 may store audio samples for performing operations with each stage of the filter in the buffer memory.

Meanwhile, in the disclosure, the buffer memory in which the audio samples are stored may mean the buffer memory within the one or more processors 160, but this is only an embodiment, and the buffer memory in which the audio samples are stored may mean the buffer memory within the memory 110.

Specifically, the electronic device 100 may store the audio samples in the buffer within the one or more processors 160. In this case, the buffer memory 1310 in which the audio samples are stored may be divided into a plurality of areas 1311, 1312, 1313, and 1314 corresponding to the plurality of stages included in the filter. In other words, when the filter includes k stages, the buffer in which the audio samples are stored may be divided into k areas.

In this case, each of the buffer memory 110 areas in which the audio samples are stored may store the number of audio samples corresponding to the number of weights per stage of the filter. In other words, when the number of weights per stage of the filter is k, the number of audio samples stored in one buffer memory area may be k.

The electronic device 100 may perform an operation between the audio sample stored in the k^{th} buffer memory area and the k^{th} stage of the filter.

As the audio samples are continuously acquired, a newly acquired audio sample 1301 may be input to the buffer memory area. The electronic device 100 may perform an operation using the buffer to which the new audio sample is input.

Specifically, when the new audio sample 1301 is acquired, the electronic device 100 may input the acquired audio sample 1301 to the first buffer memory area 1311.

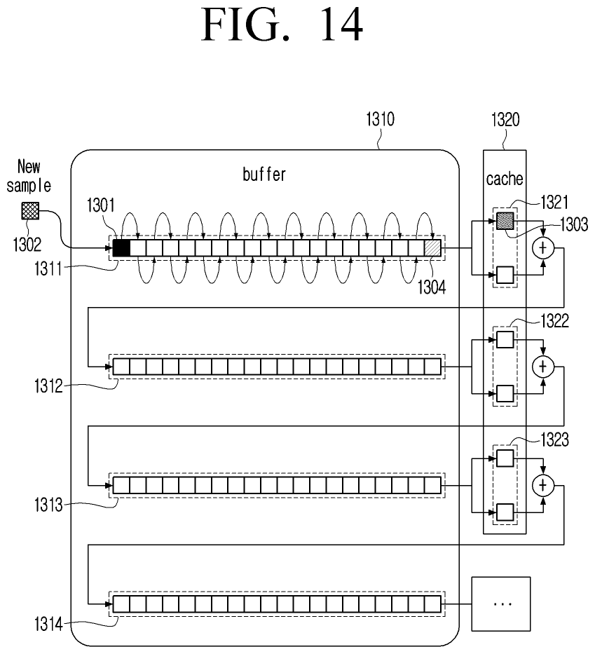

Accordingly, referring to FIG. 14, the electronic device 100 may move the oldest audio sample 1303 among the audio samples stored in the first buffer memory area 1311 from the first buffer memory area 1311 to a first cache memory area 1321. That is, the electronic device 100 may remove the oldest audio sample 1303 from the first buffer memory area 1311 and store the audio sample removed from the first buffer memory area 1311 in the first cache memory area 1321. In the disclosure, the cache memory area 1360 may mean a memory space for storing audio samples for down sampling. In this case, the number of cache memory areas may be equal to the number of buffer memory areas. The audio samples removed from the k buffer memory areas 1311, 1312, and 1313 may be moved to the k cache memory areas 1321, 1322, and 1323.

Meanwhile, in the disclosure, the cache memory 1320 in which the audio samples are stored may mean the cache memory 1320 within the one or more processors 160, but this is only an embodiment, and the buffer memory in which the audio samples are stored may mean the buffer memory within the memory 110.

In the disclosure, the “buffer memory” or “cache memory” may be replaced with an expression indicating the same/similar concept, such as “memory within the one or more processors 160” or “memory 110.”

In the disclosure, the “area” of the buffer memory or the “area” of the cache memory may be replaced with an expression indicating the same/similar concept, such as “group” or “part.”

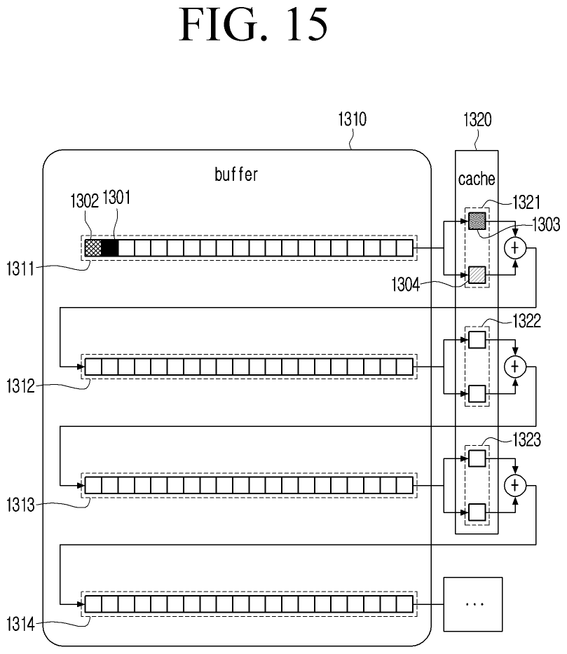

After the audio sample 1303 is moved from the first buffer memory area 1311 to the first cache memory area 1321, referring to FIG. 15, when a new audio sample 1302 is additionally input to the first buffer memory area 1311, the electronic device 100 may move the oldest audio sample 1304 from the first buffer memory area 1311 to the first cache memory area 1321.

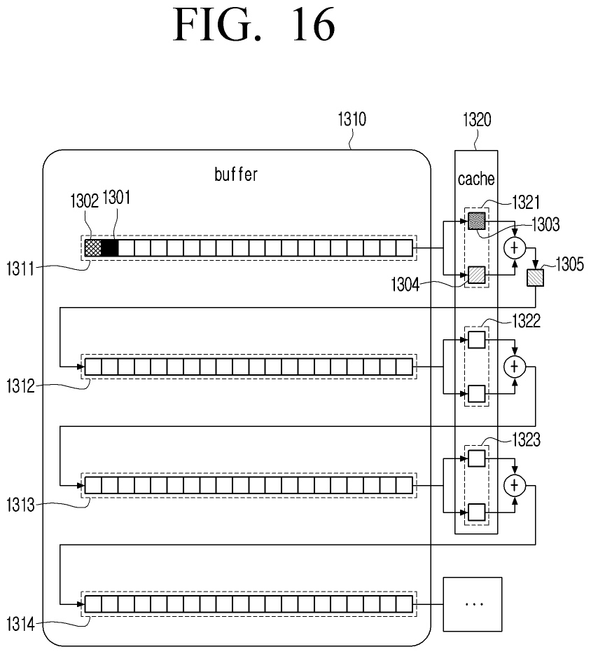

Then, referring to FIG. 16, when two audio samples 1303 and 1304 are stored in the first cache memory area 1321, the electronic device 100 may down-sample the two audio samples 1303 and 1304 into one audio sample 1305. In this case, the electronic device 100 may perform down-sampling using an average value of bit values of the two audio samples 1303 and 1304, but is not limited thereto. In this case, the bit value of the down-sampled one audio sample 1305 may be an average value of the bit values of the two audio samples 1303 and 1304. According to one or more embodiments of the disclosure, the electronic device 100 may perform the down-sampling by selecting one of the two audio samples or using a higher value of the two audio samples.

Then, when the down-sampled audio sample 1305 is generated from the two audio samples stored in the first cache memory area 1321, the electronic device 100 may remove the audio samples 1321 and 1322 stored in the first cache memory area 1321.

The electronic device 100 may input the down-sampled one audio sample 1305 to the second buffer memory area 1312. When the audio sample 1305 is input to the second buffer memory area 1312, the electronic device 100 may perform a convolution operation between the audio sample stored in the second buffer memory area 1312 and the weight of the filter.

As described with reference to the first buffer memory area 1311, when one audio sample 1305 is input to the second buffer memory area 1312, the electronic device 100 may move the oldest audio sample among the audio samples stored in the second buffer memory area 1312 from the second buffer memory area 1312 to the second cache memory area 1322. That is, the electronic device 100 may remove the oldest audio sample from the second buffer memory area 1312 and store the audio sample removed from the second buffer memory area 1312 in the second cache memory area 1322.

In this way, when two audio samples are input to the second buffer memory area 1312, the two audio samples may be stored in the second cache memory area 1322.

When two audio samples are stored in the second cache memory area 1322, the electronic device 100 may down-sample the two audio samples stored in the second cache memory area 1322 into one audio sample. In this case, the method of down-sampling by the electronic device 100 may be the same as the method described above.

The electronic device 100 may input the down-sampled one audio sample to the third buffer memory area 1313. In other words, when four audio samples are input to the first buffer memory area 1311, one audio sample may be input to the third buffer memory area 1313.

As described above, as the audio sample is acquired, the audio sample may be added to at least one buffer memory area. When the audio sample is added to the buffer memory area, the electronic device 100 may input the audio sample included in the buffer memory area to which the audio sample is added to the filter stage corresponding to the buffer memory area.

Accordingly, the first stage of the filter may perform the calculation once whenever one audio sample is acquired. The second stage of the filter may perform the calculation once whenever 21 audio samples are acquired. The third stage of the filter may perform a calculation once whenever 22 audio samples are acquired. Similarly, the fourth stage of the filter may perform the calculation once whenever 23 audio samples are acquired.

Therefore, the electronic device 100 according to the disclosure may allow the preset number (e.g., up to two) of stages among the plurality of stages to perform the calculation whenever one audio sample is acquired. That is, since not all the filter stages perform the calculation whenever the audio sample is acquired, the amount of computational resource consumption may be effectively reduced.

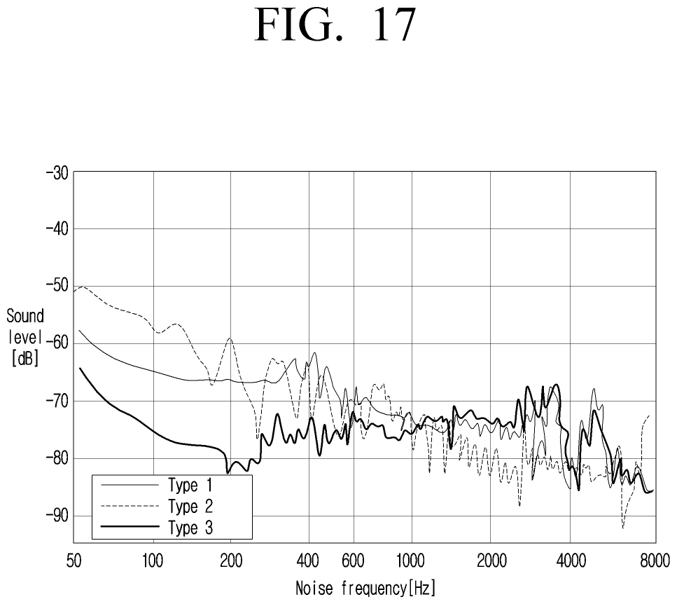

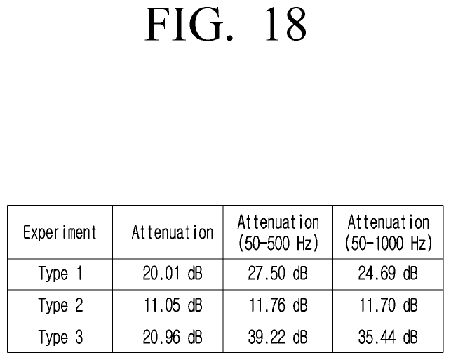

FIGS. 17 and 18 are graphs showing noise performance according to a combination of filter modules according to various embodiments of the disclosure.

Referring to FIGS. 17 and 18, noise may be more effectively cancelled when the first filter, the second filter, and the third filter are used together (Type 3) than when only the third filter of the disclosure is used alone (Type 1) or when only the first and second filters are used alone (Type 2).

Referring to FIG. 18, a combination of filter modules according to Type 3 shows a higher attenuation value than a combination of filter modules according to Type 1 or Type 2.

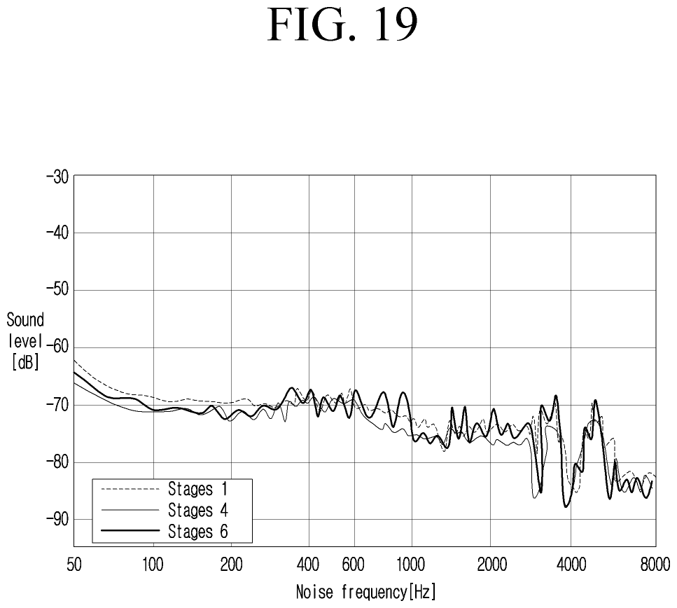

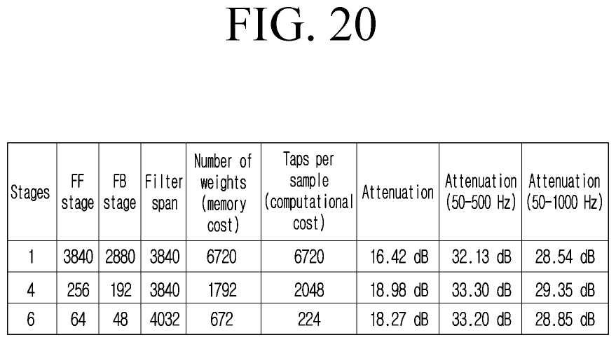

FIGS. 19 and 20 graphs showing noise performance according to a compressed degree of a filter module according to various embodiments of the disclosure.

Referring to FIGS. 19 and 20, in the disclosure, the noise cancellation performance of the filter in which the number of stages that does not perform the filter compression is 1 and a filter in which the number of stages that perform the filter compression is 4 and 6 may both effectively cancel noise.

In this case, referring to FIG. 20, the number of taps of the filter that performs the filter compression is smaller than the number of taps of the filter that does not perform the compression. Therefore, compared to the filter in which the number of stages is 1, the filter in which the number of stages is 6 has the effect of reducing computational consumption by about 1/30. That is, the noise cancellation method according to the disclosure has the effect of efficiently reducing the computational resources while effectively canceling noise.

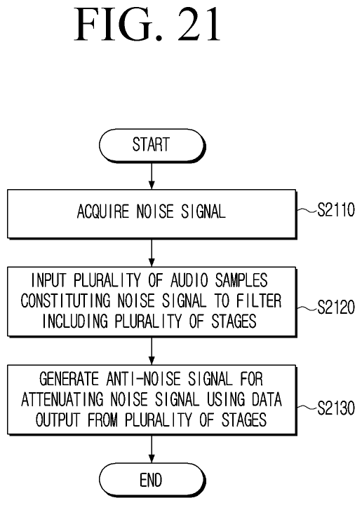

FIG. 21 is a diagram for describing a control method of an electronic device according to an embodiment of the disclosure.

Referring to FIG. 21, the electronic device 100 may acquire the noise signal in operation S2110. The electronic device 100 may acquire the noise signal through at least one microphone included in the electronic device 100.

The electronic device 100 according to the disclosure may input the plurality of audio samples constituting the noise signal to the filter including the plurality of stages in operation S2120. In this case, the electronic device 100 may input the plurality of audio samples to each of the plurality of stages at different sampling rates.

Meanwhile, the filter including the plurality of stages may be the filter in which the original filter is compressed at different levels in each of the plurality of stages. In addition, each of the plurality of stages may be the filter compressed to include the same number of coefficients.

The electronic device 100 may input the same number of audio samples to each of the plurality of stages. Meanwhile, the electronic device 100 may down-sample adjacent audio samples into one audio sample, and input the down-sampled one audio sample into one of the plurality of stages.

Meanwhile, the filter according to the disclosure may further include: the first filter configured to filter the external noise signal acquired through the external microphone; the second filter configured to generate the first feedback signal from the internal noise signal acquired through the internal microphone and have the coefficient dynamically adjusted; and the third filter configured to generate the second feedback signal from the internal noise signal acquired through the internal microphone and have the coefficient fixed.

The electronic device 100 according to the disclosure may generate the anti-noise signal for attenuating the noise signal by using the data output from the plurality of stages in operation S2130.

In the above, various embodiments each have been described, but each embodiment is not necessarily implemented individually, and may be combined wholly or in part with at least one other embodiment and implemented together in one product.

Meanwhile, the term “unit” or “module” used in the disclosure may include units configured by hardware, software, or firmware, and may be used compatibly with terms such as, for example, logics, logic blocks, components, circuits, or the like. The term “˜er/or” or “module” may be an integrally configured component or a minimum unit performing one or more functions or a part thereof. For example, the module may be configured by an application-specific integrated circuit (ASIC).

Various embodiments of the disclosure may be implemented by software including instructions stored in a machine-readable storage medium (for example, a computer-readable storage medium). A machine is a device capable of calling a stored instruction from a storage medium and operating according to the called instruction, and may include the electronic device 100 of the disclosed embodiments. In a case where a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory storage medium. Here, the term ‘non-transitory’ means that the storage medium is tangible without including a signal, and does not distinguish whether data are semi-permanently or temporarily stored in the storage medium.

According to one or more embodiment, the methods according to various embodiments disclosed in the document may be included in a computer program product and provided. The computer program product may be traded as a product between a seller and a purchaser. The computer program product may be distributed in the form of a storage medium (e.g., a compact disc read only memory (CD-ROM)) that may be read by the machine or online through an application store (e.g., PlayStore™). In a case of the online distribution, at least portions of the computer program product may be at least temporarily stored in a storage medium such as memory of a server of a manufacturer, a server of an application store, or a relay server or be temporarily created.

Each of the components (for example, modules or programs) according to the diverse embodiments may include a single entity or a plurality of entities, and some of the corresponding sub-components described above may be omitted or other sub-components may be further included in the diverse embodiments. Alternatively or additionally, some of the components (e.g., the modules or the programs) may be integrated into one entity, and may perform functions performed by the respective corresponding components before being integrated in the same or similar manner. Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device for active noise cancellation, the method comprising:
acquiring, by the electronic device, a noise signal;
inputting, by the electronic device, a plurality of audio samples constituting the noise signal to a filter including a plurality of stages; and
generating, by the electronic device, an anti-noise signal for attenuating the noise signal using data output from the plurality of stages.

2. The method as claimed in claim 1, wherein the inputting of the plurality of audio samples constituting the noise signal to the filter including the plurality of stages includes inputting the plurality of audio samples to each of the plurality of stages at different sampling rates.

3. The method as claimed in claim 1, further comprising:
compressing an original filter to a different level in each of the plurality of stages.

4. The method as claimed in claim 1, wherein each of the plurality of stages includes a same number of coefficients.

5. The method as claimed in claim 1, wherein the inputting of the plurality of audio samples constituting the noise signal to the filter including the plurality of stages includes inputting a same number of audio samples to each of the plurality of stages.

6. The method as claimed in claim 1, wherein the inputting of the plurality of audio samples constituting the noise signal to the filter divided into the plurality of stages includes:
down-sampling adjacent audio samples into one audio sample; and
inputting the down-sampled one audio sample to one of the plurality of stages.

7. The method as claimed in claim 1,
wherein the filter includes:
a first stage, and
a second stage, and
wherein the inputting of the plurality of audio samples constituting the noise signal to the filter divided into the plurality of stages includes:
inputting two audio samples to a first buffer memory corresponding to the first stage,
when the two audio samples are input to the first buffer memory, down-sampling two audio samples in the oldest order among the audio samples stored in the first buffer memory into one audio sample, and
inputting the down-sampled one audio sample to a second buffer memory corresponding to the second stage.

8. The method as claimed in claim 7, further comprising:
inputting the plurality of audio samples stored in the first buffer memory to the first stage of the filter.

9. The method as claimed in claim 1, wherein the filter further includes:
a first filter configured to filter an external noise signal acquired through an external microphone;
a second filter configured to generate a first feedback signal from an internal noise signal acquired through an internal microphone and have a coefficient dynamically adjusted; and
a third filter configured to generate a second feedback signal from the internal noise signal acquired through the internal microphone and have a coefficient fixed.

10. The method as claimed in claim 9, wherein the third filter further includes a feedback module that excludes an output of the third filter from the internal noise signal acquired through the internal microphone.

11. The method as claimed in claim 9, further comprising:
identifying a path through which a sound output from a speaker reaches the internal microphone located inside the electronic device; and
determining a coefficient of the third filter using the identified path.

12. The method as claimed in claim 11, wherein the inputting of the plurality of audio samples constituting the noise signal to the filter including the plurality of stages includes inputting the noise signal to the first filter and the second filter while determining the coefficient of the second filter.

13. An electronic device for performing active noise cancellation, the electronic device comprising:
at least one microphone;
a speaker;
memory storing one or more computer programs; and
one or more processors communicatively coupled to the at least one microphone, the speaker, and the memory,
wherein the one or more computer programs include computer-executable instructions that, when executed by the one or more processors individually or collectively, cause the electronic device to:
acquire a noise signal through the at least one microphone,
input a plurality of audio samples constituting the noise signal to a filter including a plurality of stages, and
output an anti-noise signal for attenuating the noise signal using data output from the plurality of stages.

14. The electronic device as claimed in claim 13, wherein the one or more computer programs further include computer-executable instructions that, when executed by the one or more processors individually or collectively, cause the electronic device to input the plurality of audio samples into each of the plurality of stages at different sampling rates.

15. The electronic device as claimed in claim 13, wherein the one or more computer programs further include computer-executable instructions that, when executed by the one or more processors individually or collectively, cause the electronic device to compress an original filter at different levels in each of the plurality of stages.

16. The electronic device as claimed in claim 13, wherein the filter includes:
a first stage, and
a second stage, and
wherein the one or more computer programs further include computer-executable instructions that, when executed by the one or more processors individually or collectively, cause the electronic device to:
inputting two audio samples to a first buffer memory corresponding to the first stage,
when the two audio samples are input to the first buffer memory, down-sampling two audio samples in the oldest order among the audio samples stored in the first buffer memory into one audio sample, and
inputting the down-sampled one audio sample to a second buffer memory corresponding to the second stage.

17. The electronic device as claimed in claim 13, wherein the filter further includes:
a first filter configured to filter an external noise signal;
a second filter configured to generate a first feedback signal; and
a third filter configured to generate a second feedback signal.

18. The electronic device as claimed in claim 17,
wherein the first filter is communicatively coupled to a first filter adjustment circuit, and
wherein the second filter is communicatively coupled to a second filter adjustment circuit, and a feedback circuit.

19. The electronic device as claimed in claim 17,
wherein the at least one microphone comprises an internal microphone and an external microphone,
wherein the first filter is a first finite impulse response (FIR) filter configured to output the anti-noise signal when the external noise signal acquired through an external microphone is input,
wherein the second filter is a second FIR filter configured to generate the first feedback signal from an internal noise signal acquired through the internal microphone and has a coefficient dynamically adjusted, and
wherein the third filter is configured to generate the second feedback signal from the internal noise signal acquired through the internal microphone and have a coefficient fixed.

20. One or more non-transitory computer-readable storage media storing one or more computer programs including computer-executable instructions that, when executed by one or more processors of an electronic device individually or collectively, cause the electronic device to perform operations, the operations comprising:
acquiring, by the electronic device, a noise signal;
inputting, by the electronic device, a plurality of audio samples constituting the noise signal to a filter including a plurality of stages; and
generating, by the electronic device, an anti-noise signal for attenuating the noise signal using data output from the plurality of stages.
